(19) United States
(12) Patent Application Publication
(10) Pub. No.: US 2026/0088353 A1
(43) Pub. Date: Mar. 26, 2026

(54) LITHIUM-ION SECONDARY BATTERY

(71) Applicant: ZHUHAI COSMX BATTERY CO., LTD., Zhuhai (CN)

(72) Inventors: Yuanji Wu, Zhuhai (CN); Xiping Li, Zhuhai (CN)

(21) Appl. No.: 19/315,839

(22) Filed: Sep. 1, 2025

(30) Foreign Application Priority Data
Sep. 26, 2024 (CN) 202411352777.4

(51) Int. Cl. H01M 10/0567; H01M 4/587; H01M 10/0525; H01M 10/0569

(52) U.S. Cl. CPC H01M 10/0567; H01M 4/587; H01M 10/0525; H01M 10/0569; H01M 2300/0042

(57) ABSTRACT

The present disclosure relates to a lithium-ion secondary battery. The battery comprises a negative electrode plate, comprising a negative electrode active material which comprises a silicon-carbon material. the silicon-carbon material comprises a porous carbon substrate and a silicon material distributed within pores of the porous carbon substrate; and the sphericity of the silicon-carbon material is denoted as Q, with the sphericity Q being 0.5-1. the electrolyte solution comprises a carboxylate ester solvent and a sulfur-containing heterocyclic compound, wherein the mass percentages of the carboxylate ester solvent and the sulfur-containing heterocyclic compound are denoted as E % and S %, respectively, based on the total mass of the electrolyte solution; and E and S satisfy 10≤E/S≤100, which can enable lithium-ion batteries to have a good kinetic performance, a higher energy density, a better cycling stability and a better thermal safety performance.

### CROSS-REFERENCE TO RELATED APPLICATIONS

The present application claims priority to Chinese Patent Application No. 202411352777.4, titled “LITHIUM-ION SECONDARY BATTERY,” filed on Sep. 26, 2024, the entire contents of which are incorporated herein by reference.

### TECHNICAL FIELD

The present disclosure relates to the technical field of lithium batteries, in particular to a lithium-ion secondary battery.

### BACKGROUND ART

In recent years, with the popularity of electric vehicles and portable devices, the requirements on the performance of lithium batteries are getting higher and higher. Silicon-based materials can store more lithium ions in the same volume and weight than conventional graphite negative electrodes because of their relatively high theoretical capacity, greatly increasing the energy density of the battery. However, the existing silicon-based materials are prone to significantly change in volume during charge and discharge processes, which leads to the deformation and cracking of a silicon-carbon negative electrode, thereby increasing the direct contact of the silicon-based material with the electrolyte solution, and more side reactions occur, resulting in severe gas and heat generation in a battery, and safety issues such as battery fires are prone to occur. Furthermore, the increase in side reactions further results in the thickening of the SEI membrane, which leads to the increase of the internal resistance of the battery which hinders the transport of lithium ions, and the cracking of the electrode plate disrupts the originally continuous transport paths for electrons and ions, which also hinders the transport of lithium ions, thus affecting the kinetic performance of the battery.

### SUMMARY

The object of the present disclosure is to overcome the above problems existing in the prior art by providing a lithium-ion secondary battery in which by adding a carboxylate ester solvent and a sulfur-containing heterocyclic compound to an electrolyte solution and adding a silicon-carbon material with a specific structure to a negative electrode plate, and by further adjusting the relationship between the sphericity of the silicon-carbon material and the mass percentage of the sulfur-containing heterocyclic compound in the electrolyte solution, the relationship between the mass percentages of the carboxylate ester solvent and the sulfur-containing heterocyclic compound in the electrolyte solution, a lithium-ion battery can have a good kinetic performance, a better cycling stability and a better thermal safety performance.

To achieve the above object, the present disclosure provides a lithium-ion secondary battery. The battery comprises a positive electrode plate, a negative electrode plate, and an electrolyte solution, wherein
the negative electrode plate comprises a negative electrode active material, wherein the negative electrode active material comprises a carbon-based material and a silicon-based material, the silicon-based material comprises a silicon-carbon material, the silicon-carbon material comprises a porous carbon substrate and a silicon material distributed within pores of the porous carbon substrate, and the silicon-carbon material has a sphericity Q of 0.5-1;
the electrolyte solution comprises a carboxylate ester solvent, based on the total mass of the electrolyte solution, the mass percentage of the carboxylate ester solvent is denoted as E %; and
the electrolyte solution comprises a sulfur-containing heterocyclic compound, based on the total mass of the electrolyte solution, the mass percentage of the sulfur-containing heterocyclic compound is denoted as S %; and
E and S satisfy: 10≤E/S≤100.

In the present disclosure, the above technical solutions are used and have the following beneficial effects:

In the lithium-ion secondary battery provided by the present disclosure, by adding a carboxylate ester solvent and a sulfur-containing heterocyclic compound to the electrolyte solution and using a silicon-carbon material with a specific structure in the negative electrode, the silicon-carbon material comprising a porous carbon substrate and a silicon material distributed within pores of the porous carbon substrate, and by further adjusting the sphericity Q of the silicon-carbon material in the range of 0.5-1, and meanwhile adjusting the mass percentage E of the carboxylate ester solvent and the mass percentage S of the sulfur-containing heterocyclic compound in the electrolyte solution to satisfy 10≤E/S≤100, the lithium-ion battery can have a good kinetic performance, a better cycling stability and a better thermal safety performance.

The endpoints of ranges and any values disclosed herein are not limited to such exact ranges or values, and these ranges or values should be understood to include values close to these ranges or values. For numerical value ranges, one or more new numerical value ranges can be obtained between endpoint values of various ranges, between endpoint values of various ranges and individual point values, and between individual point values, and these numerical value ranges should be regarded as specifically disclosed herein. In the present disclosure, unless otherwise specified, all the numerical ranges are inclusive of the endpoints.

### BRIEF DESCRIPTION OF THE DRAWINGS

FIG. 1 shows a structural schematic diagram of a negative electrode active material layer in an embodiment of the present disclosure.

FIG. 2 shows another structural schematic diagram of the negative electrode active material layer in an embodiment of the present disclosure.

FIG. 3 shows a cross-sectional schematic diagram of a silicon-carbon material in an embodiment of the present disclosure.

Reference signs: 1. Recessed region; 2. Depression; 3. Negative electrode active material layer; 4. Silicon material; 5. Porous carbon backbone; 6. Carbon coating layer.

### DETAILED DESCRIPTION OF EMBODIMENTS

Hereinafter, specific embodiments of the present disclosure will be described in detail. It should be understood that the specific embodiments described herein are only used to illustrate and explain the present disclosure and are not used to limit the present disclosure.

Unless otherwise defined, all scientific and technical terms used in the present disclosure have the same meanings as commonly understood by those skilled in the technical field to which the present disclosure relates.

In the present disclosure, the terms “battery”, “lithium battery”, “lithium-ion battery” and “lithium-ion secondary battery” all have the same meaning and refer to a lithium-ion secondary battery, generally including an electrode assembly (e.g., a positive electrode plate, a negative electrode plate, and a separator), a container (housing) for accommodating the electrode assembly, and an electrolyte.

The present disclosure provides a lithium-ion secondary battery. The battery comprises a positive electrode plate, a negative electrode plate, and an electrolyte solution, wherein
the negative electrode plate comprises a negative electrode active material, wherein the negative electrode active material comprises a carbon-based material and a silicon-based material, the silicon-based material comprises a silicon-carbon material, the silicon-carbon material comprises a porous carbon substrate and a silicon material distributed within pores of the porous carbon substrate, and the silicon-carbon material has a sphericity Q of 0.5-1;
the electrolyte solution comprises a carboxylate ester solvent, based on the total mass of the electrolyte solution, the mass percentage of the carboxylate ester solvent is denoted as E %; and
the electrolyte solution comprises a sulfur-containing heterocyclic compound, based on the total mass of the electrolyte solution, the mass percentage of the sulfur-containing heterocyclic compound is denoted as S %; and
E and S satisfy: 10≤E/S≤100.

By way of example, the sphericity Q can be, for example, 0.5, 0.6, 0.7, 0.8, 0.9, 1 or any point value in a range consisting of two of the above point values.

By way of example, the value of E/S may be, for example, 10, 20, 30, 40, 50, 60, 70, 80, 90, 100, or any point value in a range consisting of two of the above point values.

In some embodiments, as shown in FIG. 3, the silicon-carbon material comprises a core and a carbon coating layer 6 coating the core, wherein the core comprises a porous carbon substrate 5 and silicon material 4 distributed within the pores of the porous carbon substrate.

According to the present disclosure, a silicon-carbon material with a specific structure is added to the negative electrode plate. The structure of the porous carbon substrate in the core of the silicon-carbon material is not only beneficial to the deposition of silicon materials, but also can reduce the polarization during the lithium intercalation/deintercalation of silicon materials due to the good electrical conductivity thereof. The presence of channels (gaps or pores) in the porous carbon substrate can also confine the size of the silicon materials in the pores, such that the size of the silicon materials is not too large, which makes the structure of the silicon-carbon material more suitable for the rapid lithium-ion intercalation/deintercalation and improves the kinetic performance of the battery. However, although the silicon-carbon material can improve the kinetic performance of the battery to a certain extent, the thermal safety problems caused by the volume expansion of silicon-containing negative electrodes still exists. According to the present disclosure, the sulfur-containing heterocyclic compound is added to the electrolyte solution. On the one hand, the sulfur-containing heterocyclic compound can form a film on the surface of the positive electrode, inhibiting dissolution of the positive electrode metal ions; and on the other hand, the sulfur-containing heterocyclic compound can also form a film on the surface of the negative electrode, which is beneficial to inhibit the volume expansion of the silicon-containing negative electrode; such that not only the cycling stability of the silicon-carbon material can be improved, but also the gas generation at elevated temperatures of the lithium-ion battery can be suppressed, thereby improving the thermal safety performance and cycling life of the lithium-ion battery.

The sulfur-containing heterocyclic compound acts on the surface of the negative electrode, and the silicon-carbon particles will affect the overall appearance and morphology of the SEI membrane formed by the negative electrode. If the sphericity of the silicon-carbon material is too low, the silicon-carbon particles will expand/contract during the charging/discharging of the battery, resulting in the stress-strain concentration in the local region of the negative electrode, where the SEI membrane is prone to repeated cracking and formation, resulting in the poor thickness uniformity of the formed SEI membrane and increased consumption of electrolyte solution. Through further studies, the inventors have found that when the sphericity (Q) of the silicon-carbon material is in the range of 0.5-1, the silicon-carbon particles are more rounded, such that the distributions of the sulfur-containing heterocyclic compound in the silicon-carbon particle region and on the surface of the negative electrode are more uniform, and the resulting SEI film thickness is also more uniform, which improves suppression effects of silicon-containing negative electrode expansion and gas generation at elevated temperatures of the battery, and further improves the thermal safety performance and cycling life of the lithium-ion battery.

The sulfur-containing heterocyclic compound in the electrolyte solution can increase the impedance of the battery and reduce the kinetic performance of the battery. According to the present disclosure, by using a linear carboxylate ester in combination with a sulfur-containing heterocyclic compound, and adjusting the mass percentage (E) of the carboxylate ester solvent and the mass percentage (S) of the sulfur-containing heterocyclic compound to satisfy 10≤E/S≤100, the decrease in the kinetic performance due to the increase in the electrolyte solution viscosity caused by adding a sulfur-containing heterocyclic compound to an electrolyte solution can be compensated; and in addition, the use of the linear carboxylate ester in combination with the sulfur-containing heterocyclic compound can also improve the fluidity of the sulfur-containing heterocyclic compound and further improve the film-forming uniformity thereof.

According to the present disclosure, by adjusting the sphericity Q to be in the range of 0.5-1, the problem can be avoided that the solid electrolyte membrane is prone to repeated cracking and formation in the local region due to too concentrated stress and strain when the sphericity of the silicon-carbon material is too low, causing excessive consumption of the electrolyte solution, and the problem can be also avoided that the lithium ion migration speed difference in different regions on the surface of the material is too large due to uneven solid electrolyte membrane, which further aggravates the imbalance of the stress and strain.

By way of example, the test method for sphericity Q may comprise the steps of: The image of each particle in an SEM micrograph of the composite material at a given magnification (e.g., 2500×) was analyzed by means of image processing software (e.g., Image Pro Plus), so as to obtain the perimeter and area of each particle; the perimeter-equivalent radius r1 and the area-equivalent radius r2 of each particle were separately calculated, and then the sphericity S of each particle satisfied S=r2/r1; and the number-weighted average of the sphericity of all the particles was calculated so as to obtain the average sphericity of the silicon-carbon composite material.

In summary, according to the present disclosure, by using a silicon-carbon material with a specific structure in the negative electrode plate, adjusting the sphericity Q in the range of 0.5-1, and when E and S satisfy 10≤E/S≤100, the lithium-ion battery can have a good kinetic performance, a better cycling stability and a better thermal safety performance.

In some embodiments, the mass percentage E of the carboxylate ester solvent is 30%-60%, and the mass percentage E of the carboxylate ester solvent may be, for example, 30%, 35%, 40%, 45%, 50%, 55%, 60%, or any point value in a range consisting of two of the above point values. When E further satisfies the above range, the viscosity of the electrolyte solution can be further reduced, and the conductivity of the electrolyte solution can be improved, and thus better kinetic performance can be obtained. When the mass percentage E of the carboxylate ester solvent satisfies the range of 30%-60%, the unobvious improvement effect in the kinetic performance when E<30% and the deterioration of the high-temperature performance of the battery when E>60% can be avoided.

In some embodiments, the mass percentage S of the sulfur-containing heterocyclic compound is 0.5%-5%, and the mass percentage S of the sulfur-containing heterocyclic compound can be, for example, 0.5%, 1%, 1.5%, 2%, 2.5%, 3%, 3.5%, 4%, 4.5%, 5% or any point value in a range consisting of two of the above point values. When S further satisfies the above range, the following can be avoided: the solid electrolyte membrane formed by the sulfur-containing heterocyclic compound on the surfaces of the positive and negative electrode materials is too thin and uneven when S<0.5%, which has the disadvantage of limited improvement in the cycling and thermal stability of the lithium-ion battery; and the following can also be avoided: the solid electrolyte membrane formed by the sulfur-containing heterocyclic compound on the surfaces of the positive and negative electrodes is too thick when S>5%, resulting in excessive impedance of the lithium-ion battery, thereby deteriorating the charging window and cycling life of the lithium-ion battery. When the mass percentage S of the sulfur-containing heterocyclic compound further satisfies the range of 0.5%-5%, the side reactions on the surfaces of the positive and negative electrode materials are further suppressed, the cycling stability of the silicon-carbon material is improved, the gas generation at elevated temperatures of the battery is suppressed, and the cycling life and thermal safety performance of the battery are further improved.

In some embodiments, the sulfur-containing heterocyclic compounds comprise sulfur-containing polyheterocyclic compounds A, and/or sulfur-containing monoheterocyclic compounds B. By way of example, the sulfur-containing heterocyclic compound may be a sulfur-containing polyheterocyclic compound A, a sulfur-containing monoheterocyclic compound B, or a combination of sulfur-containing polyheterocyclic compound A and sulfur-containing monoheterocyclic compound B. As used herein, “polyheterocyclic” refers exclusively to a compound containing two or more heterocyclic rings, “monoheterocyclic” refers exclusively to a compound containing exactly one heterocyclic ring, and “heterocyclic” refers to a cyclic group containing different atoms, e.g. a cyclic group containing both S and C, or S, C and O, or S, C, O, N, etc.

To further improve the cycling life and thermal safety performance of the battery, in some embodiments, the sulfur-containing heterocyclic compound comprises: a sulfur-containing polyheterocyclic compound A and a sulfur-containing monoheterocyclic compound B. Although the sulfur-containing polyheterocyclic compound A has a relatively high viscosity and forms a film with high impedance on the positive and negative electrodes, it is easier to form similar macromolecular cross-linked products, and is capable of forming a more stable solid-state electrolyte membrane on the surfaces of the positive and negative electrodes due to the larger molecular weight, more functional groups, and abundant reaction sites thereof, and thus the lithium-ion battery can have a better cycling life and the stability of the battery in extreme thermal conditions can be improved. Because of the relatively small molecular weight, the sulfur-containing monoheterocyclic compound B is slightly less stable in film formation at the positive and negative electrodes than the sulfur-containing polyheterocyclic compound A, but the sulfur-containing monoheterocyclic compound B is relatively more soluble and it is easier to exist stably in the electrolyte solution in a normal environment. During the thermal storage, the sulfur-containing monoheterocyclic compound B can continue to react on the positive and negative surfaces to form a film, which suppresses the reaction rate of other side reactions, and reduces the gas generation rate of lithium-ion batteries during thermal storage. The use of a sulfur-containing polyheterocyclic compound A in combination with a sulfur-containing monoheterocyclic compound B in a lithium-ion electrolyte solution can have the advantages of both, and further improve the cycling life and thermal safety performance of lithium-ion batteries.

In some embodiments, the mass ratio of the sulfur-containing polyheterocyclic compound A to the sulfur-containing monoheterocyclic compound B is (2-6):1. When the relationship between the two further satisfies the above range, since the content of the sulfur-containing polyheterocyclic compound A is higher than that of the sulfur-containing monoheterocyclic compound B, the proportion of compounds (e.g. organic sulfonate compounds or organic sulfate compounds) generated by the decomposition of the sulfur-containing polyheterocyclic compound A is higher in the SEI membrane formed on the surface of the negative electrode, and the SEI membrane formed thereby has a better mechanical elasticity, such that the volume expansion of the silicon-containing negative electrode can be better constrained, and the stability of the SEI membrane is maintained; therefore, lithium-ion batteries have a better cycling capacity retention rate. Moreover, there is a synergistic effect between an appropriate amount of a sulfur-containing monoheterocyclic compound B and a sulfur-containing polycyclic compound A, which enable the lithium ion to have a better thermal safety performance.

In some embodiments, the sulfur-containing polyheterocyclic compound A comprises at least one of the following compounds:

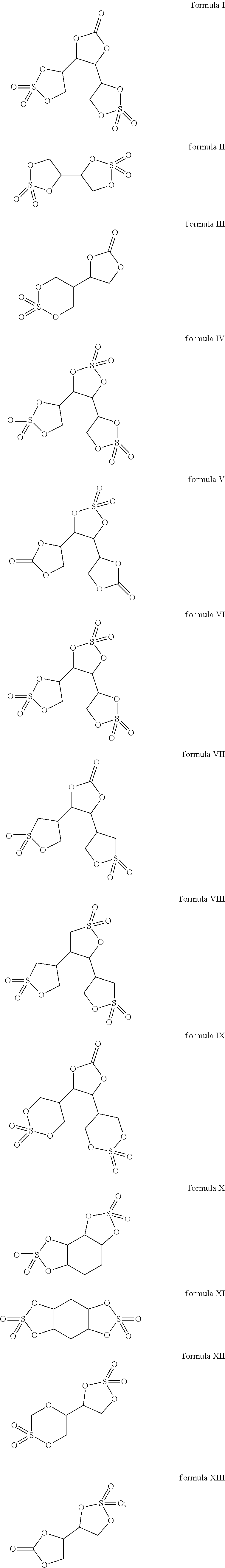

and/or, the sulfur-containing monoheterocyclic compound B comprises at least one of the following compounds:

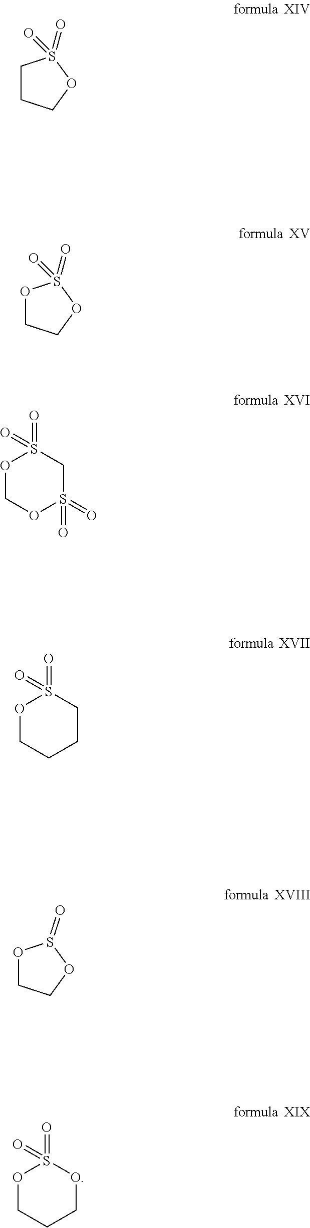 [SMILES: O=S1(=O)CCCO1 ; O=S1(=O)OCCO1 ; O=S1(=O)CS(=O)(=O)OCO1 ; O=S1(=O)CCCCO1 ; O=S1OCCO1 ; O=S1(=O)OCCCO1]

Further selection of the above-mentioned sulfur-containing heterocyclic compounds can make the solid electrolyte membrane formed on the positive and negative electrode surfaces more stable, and further suppress the volume expansion of the silicon-containing negative electrode and the dissolution of the metal ions of the positive electrode material, thereby suppressing the gas generation at elevated temperatures of the lithium-ion battery while improving the cycling stability of the silicon-carbon material, and further improving the thermal safety performance and cycling life of the lithium-ion battery.

In some embodiments, the mass content of silicon element in the silicon-carbon material is 35%-70%, and the mass content of silicon element can be, for example, 35%, 40%, 45%, 50%, 55%, 60%, 65%, 70% or any point value in a range consisting of two of the above point values. When the mass content of silicon element in the silicon-carbon material further satisfies the above-mentioned range, it is possible to ensure that the lithium-ion battery has good thermal safety performance and cycling life, and the negative electrode material has a higher lithium storage capacity per gram, which further increases the energy density of the lithium-ion battery.

And/or, the silicon carbon composite material in the silicon-carbon material has the following volume distributions: Dv10 of 3 μm-6 μm, Dv50 of 6 μm-12 μm, and Dv90 of 12 μm-25 μm. When the volume distribution particle size of the silicon-carbon material is further adjusted to satisfy the above range, the specific surface area of the material can be further optimized, and the effective reaction interface can be increased, which are conducive to improving the capacity and cycling life of the battery.

And/or, the silicon-carbon material comprises a carbon coating layer coating the surfaces of the porous carbon substrate and the silicon material. The carbon coating layer has a thickness of 10 nm-500 nm, and the thickness of the carbon coating layer can be, for example, 10 nm, 50 nm, 100 nm, 150 nm, 200 nm, 250 nm, 300 nm, 350 nm, 400 nm, 450 nm, 500 nm or any point value in a range consisting of two of the above point values. When the thickness of the carbon coating layer is further adjusted to satisfy the above range, the following can be effectively avoided: when the thickness of the carbon coating layer is <10 nm, the coating layer has a weaker binding force on the core, and is prone to cracking during the lithium intercalation/deintercalation, thereby deteriorating the properties of the material; and the following can also be avoided: when the thickness of the carbon coating layer is >500 nm, the intercalation distance of lithium ions to the silicon material will be increased, resulting in the deterioration in the kinetic performance of the material. Therefore, when the thickness of the carbon coating layer is controlled in the above range, the silicon-carbon composite material can have a better balance of kinetics and cycling stability.

In the prior art, the rolling process method is commonly used, such that the thicknesses of the positive and negative electrode plates are smaller, and the energy density of the lithium-ion battery is further improved. However, the rolling process often leads to higher compacted densities in the positive and negative electrode materials and relatively reduced porosity between the materials, which are detrimental to the infiltration and storage of the electrolyte solution and more likely to cause interface problems associated with poor lithium precipitation or intercalation. Furthermore, the rolling process will increase the degree of fragmentation of hard particles to a certain extent, such as silicon in a silicon-carbon composite material, which results in more electrolyte solution consumption. Therefore, a high compacted density will lead to poor electrolyte solution storage and infiltration, and the combination with the increased electrolyte solution consumption will further worsen interface problems such as lithium precipitation.

First of all, in the present disclosure, controlling the sphericity Q of the silicon-carbon material at a higher level (Q satisfies 0.5≤Q≤1) can suppress the degree of fragmentation of the silicon-carbon material to a certain extent, which is beneficial to reducing the consumption of electrolyte solution.

Secondly, in order to make the lithium-ion battery have a higher energy density and further solve the above-mentioned problems caused by the rolling process, the present disclosure further proposes on the basis of the above-mentioned original embodiment: the negative electrode plate comprises a negative electrode current collector and a negative electrode active material layer disposed on at least one surface of the negative electrode current collector; the negative electrode active material layer is provided with a recessed region which comprises at least one depression; the negative electrode active material layer comprises the negative electrode active material; the depth of the depression is denoted as X μm, X satisfying 5≤X≤45, preferably 5≤X≤30; and/or, the silicon-carbon material has an oil absorption value which is denoted as Y mL/100 g, Y satisfying: 10≤Y≤100, preferably 20≤Y≤50.

When X and/or Y further satisfy the above ranges, the lithium-ion battery can have an appropriate amount of the residual electrolyte solution, the negative electrode plate has a better adhesion to the separator, and the lithium-ion battery is not easy to deform, which are beneficial to enhancing the mass transfer at the positive and negative electrodes, reduce the ion impedance, shorten the transport distance of lithium ions, improve the infiltration of the electrolyte solution, improve the electrolyte retention capacity of the battery, mitigate the problem of lithium precipitation and improve the energy density of the battery to a certain extent.

In some embodiments, the depth X of the depression may be, for example, 5 μm, 8 μm, m, 12 μm, 15 μm, 17 μm, 20 μm, 22 μm, 25 μm, 27 μm, 30 μm, 35 μm, 40 μm, 45 μm or any point value in a range consisting of two of the above point values. When the depth X of the depression further satisfies the above range, the following can be avoided: when X<5, the kinetic improvement of the battery is limited, and when X>30, it is easy to cause the concentrated release of the stress and strain of the electrode material, thereby deforming the battery during the cycling; and it is possible to increase the infiltration of the electrolyte solution with hardly reducing the energy density of the battery and shorten the diffusion distance of lithium ions toward the interior, thereby improving the rapid charging capacity of the lithium-ion battery and mitigating the problems such as lithium precipitation at interfaces caused by rolling. In addition, the space formed by depressions can also act as a storage space for electrolyte solution, which is beneficial to improving the cycling life and capacity retention rate of the battery.

In the present disclosure, the depth X of the depression is the vertical distance from the surface of the negative electrode active material layer to the bottom of the recessed region.

In the present disclosure, the negative electrode active material layer has a thickness of 70 μm-140 μm. By way of example, the thickness of the negative electrode active material layer may be, for example, 70 μm, 80 μm, 90 μm, 100 μm, 110 μm, 120 μm, 130 μm, 140 μm or any point value in a range consisting of two of the above point values.

In the present disclosure, the depth X of the depression is <the thickness of the negative electrode active material layer, the depression does not penetrate the current collector.

In some embodiments, the oil absorption number Y of the silicon-carbon material may be, for example, 10 mL/100 g, 20 mL/100 g, 30 mL/100 g, 40 mL/100 g, 50 mL/100 g, 60 mL/100 g, 70 mL/100 g, 80 mL/100 g, 90 mL/100 g, 100 mL/100 g or any point value in a range consisting of two of the above point values. When the oil absorption value Y further satisfies the above range, the following can be avoided: the problems of the poor electrolyte solution infiltration when Y<10, and the silicon-carbon material is prone to expansion and deformation when Y>1000, further improving the electrolyte solution infiltration and electrolyte retention capacity of the silicon-carbon material, while maintaining the structural integrity thereof and good adhesion to the adhesive.

By way of example, the test method for oil absorption value Y may comprise the steps of: weighing the mass of a clean beaker and glass rod, denoting the mass as m1, adding 5 g of a composite material, denoting the total mass as m2, adding dioctyl phthalate (DOP) dropwise with a titration flask, stirring same thoroughly, stopping the addition of DOP when a lump forms and weighing the total weight of the beaker at this time and denoting same as m3. The oil absorption value Y=(m3−m2)/(m2−m1)*100.

In some embodiments, the contour of the depression is at least one of a linear groove, a regular hole shape, or an irregular hole shape.

In some embodiments, the contour of the depression is a linear groove, and the distance between adjacent two linear grooves is 1 mm-3 mm, and can be, for example, 1 mm, 1.5 mm, 2 mm, 2.5 mm, 3 mm, or any point value in a range consisting of two of the above point values. When the distance between two adjacent linear grooves further satisfies the above-mentioned range, the following can be avoided: due to the larger strain during lithium intercalation/deintercalation in the electrode material during cycling of the battery, the distance of the adjacent linear grooves too close to cause too much internal space formed by the depressions to easily induce the concentrated release of the stress and strain of the negative electrode, thereby deforming the battery during the cycling, and the following can be prevented: the weakened adhesion caused by overly proximate grooves, which leads to increased battery deformation and interfacial issues such as lithium precipitation, and deteriorate the cycling life of the lithium-ion battery; and the following can also be avoided: the limited kinetic improvement of the battery when adjacent linear grooves are too far away. Therefore, when the distance between adjacent two linear grooves further satisfies the above range, the negative electrode plate can have better adhesion to the separator, the lithium-ion battery is less prone to deformation, the infiltration of the electrolyte solution is further improved, and the electrolyte retention capacity of the battery is improved, and the problem of lithium precipitation at interfaces in lithium-ion batteries is mitigated, such that the lithium-ion battery has a fast charging capability, a high energy density and a long cycling life.

In some embodiments, when the contour of the depression is a regular hole shape or an irregular hole shape, the distance between adjacent two holes is 100 μm-300 μm, and can be, for example, 100 μm, 150 μm, 200 μm, 250 μm, 300 μm or any point value in a range consisting of two of the above point values. Similar to the technical effect achieved where the distance between the adjacent two linear grooves is further 1 mm-3 mm as described above, when the distance between the adjacent two holes of the regular or irregular hole shape further satisfies the above range, the infiltration of the electrolyte solution can be further improved, the electrolyte retention capacity of the battery can be improved, the problem of lithium precipitation at interfaces in lithium-ion batteries is mitigated, such that the lithium-ion battery has a fast charging capability, a high energy density and a long cycling life.

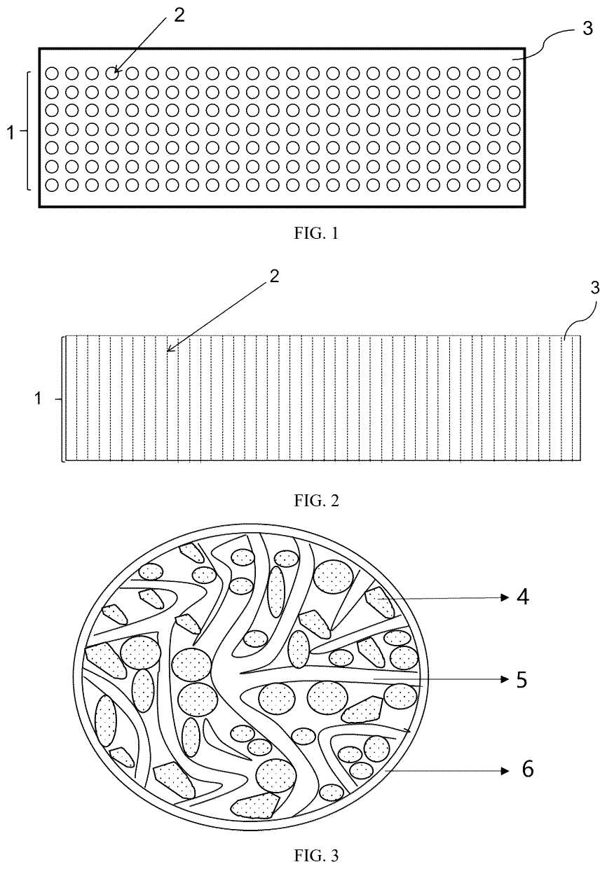

In some embodiments, as shown in FIG. 1, a negative electrode active material layer 3 is provided with a recessed region 1, the recessed region 1 being provided with a plurality of depressions 2 distributed at intervals, the depression 2 being of a regular hole shape.

In some embodiments, as shown in FIG. 2, a negative electrode active material layer 3 is provided with a recessed region 1, the recessed region 1 being provided with a plurality of depressions 2 distributed at intervals, the depression 2 being a linear groove.

The battery further comprises a separator. The separator comprises a porous substrate, a heat-resistant coating, and a porous adhesive layer, which are sequentially stacked, wherein the heat-resistant coating comprises inorganic particles which have a Dv50 denoted as W m; and S and W satisfy: 0.5≤S/W≤20. The value of S/W may be, for example, 0.5, 1, 2, 3, 4, 5, 6, 7, 8, 9, 10, 11, 12, 13, 14, 15, 16, 17, 18, 19, 20 or any point value in a range consisting of two of the above point values. Preferably, S and W satisfy: 1≤S/W≤15. When S and W further satisfy the above range, the sulfur-containing heterocyclic compound can passivate some of the dust remaining when the recessed regions are formed during the film formation on the negative electrode, and the inorganic particles can effectively block the contact of the positive and negative electrode dusts by increasing their coverage, thereby collectively improving the self-discharge of the battery and also extending the migration path of dissolved metal ions toward the negative electrode, thus prolonging the thermal safety stability of lithium-ion batteries. In addition, when the Dv50 of the inorganic particles is within the above range, the particles can have well-distributed channels and a reasonable surface area, enabling the inorganic heat-resistant coating to have a higher electrolyte absorption capacity. Therefore, the synergistic effect between the inorganic heat-resistant coating and the sulfur-containing heterocyclic compound can make the prepared lithium-ion battery have a better ability to suppress self-discharge and a better thermal safety performance.

By way of example, the structure of the separator may comprise: porous adhesive layer+heat-resistant layer+porous substrate+porous adhesive layer and porous adhesive layer+heat-resistant layer+porous substrate+heat-resistant layer+porous adhesive layer. Preferably, the structure of the separator is the structure of porous adhesive layer+heat-resistant layer+porous substrate+porous adhesive layer (the heat-resistant layer is provided on the side close to the positive electrode plate).

In some embodiments, the inorganic particles are selected from at least one of inorganic metal oxides, inorganic metal nitrides, and inorganic metal salts.

By way of example, the inorganic metal oxides comprise boehmite, alumina, magnesium oxide, calcium oxide, titanium dioxide, silica and zirconium dioxide.

By way of example, the inorganic metal nitrides comprise tungsten nitride, silicon carbide, boron nitride, aluminum nitride, titanium nitride and magnesium nitride.

By way of example, the inorganic metal salts comprise barium sulfate, calcium titanate, and barium titanate.

In some embodiments, the Dv50 (W) of the inorganic particles is 0.2 μm-2 μm, and can be, for example, 0.2 μm, 0.4 μm, 0.8 μm, 1 μm, 1.2 μm, 1.4 μm, 1.6 μm, 1.8 μm, 2 μm or any point value in a range consisting of two of the above point values. When S and W satisfy 0.5≤S/W≤20, and the Dv50 of the inorganic particles further satisfies the above range, the coverage of the inorganic particles on the electrode plates can be increased, the contact between the positive and negative electrode dusts can be further prevented, thereby improving the self-discharge of the lithium-ion battery.

In some embodiments, the adhesion between the separator and the negative electrode plate is >5 N/m. When S and W satisfy 0.5≤S/W≤20, and the adhesion between the separator and the negative electrode plate further satisfies the above range, the following can be effectively avoided: due to the adhesion <5 N/m, because of the repeated expansion and contraction of the negative electrode plate during the cycling, the separator and the negative electrode material are easily peeled off, resulting in a longer transport distance of lithium ions and kinetic deterioration, thereby resulting in interfacial undesirable phenomena such as interfacial lithium precipitation or dark spots, purple spots.

In some embodiments, the thickness of the porous substrate of the separator is 3 μm-8 am, and can be, for example, 3 μm, 3.5 μm, 4 μm, 4.5 μm, 5 μm, 5.5 μm, 6 μm, 6.5 μm, 7 μm, 7.5 μm, 8 μm, or any point value in a range consisting of two of the above point values.

In some embodiments, the porous substrate can comprise at least one of polypropylene, polyethylene, polyvinylidene fluoride, polytetrafluoroethylene, and polyimide.

In some embodiments, the thickness of the heat-resistant coating is 0.5 μm-3 μm, and can be, for example, 0.5 μm, 1 μm, 1.5 μm, 2 μm, 2.5 μm, 3 μm, or any point value in a range consisting of two of the above point values.

In some embodiments, the thickness of the porous adhesive layer is 0.5 μm-3 μm, and can be, for example, 0.5 μm, 1 μm, 1.5 μm, 2 μm, 2.5 μm, 3 μm, or any point value in a range consisting of two of the above point values.

In some embodiments, the porous adhesive layer can comprise at least one of polyvinylidene fluoride (PVDF), polymethyl methacrylate, a polytetrafluoroethylene-ethylene copolymer, polytetrafluoroethylene, methacrylate, and a styrene-butadiene rubber.

In some embodiments, the carboxylate ester solvent comprises a C1-C10 carboxylate ester solvent. When Q, E and S satisfy: when further selecting the above carboxylate ester solvents, it can be more conducive to reducing the viscosity of the electrolyte solution and improving the conductivity of the electrolyte solution, thereby obtaining a better kinetic performance.

By way of example, the C1-C10 carboxylate ester solvent comprises one or more of n-propyl propionate, ethyl propionate, methyl propionate, n-butyl propionate, methyl acetate, ethyl acetate, n-propyl acetate, n-butyl acetate, methyl butyrate, ethyl butyrate and propyl butyrate.

In some embodiments, the positive electrode plate comprises a positive electrode active material which comprises a lithium cobaltate-based layered oxide material. The use of lithium cobaltate-based layered oxide materials in lithium-ion batteries is beneficial for lithium-ion batteries to achieve a higher energy density because the lithium cobaltate-based layered oxide materials have a higher capacity and a higher voltage platform and can obtain a higher compacted density.

In some embodiments, the lithium cobaltate-based layered oxide material comprises a carbon coating layer.

In some embodiments, the lithium cobaltate-based layered oxide material comprises a doping element. By way of example, the doping element comprises, but not limited to, at least one of Na, K, Cs, Mg, Ca, Ba, Al, Ti, Ta, Ni, Fe, Mn, W, Sc, Tc, Zr, Ta, Sr and Y.

In some embodiments, the mass percentage content of each component in the positive electrode active material layer is as follow: a positive electrode active material: 90 wt %-99.4 wt %, a conductive agent: 0.3 wt %-5 wt %, and an adhesive: 0.3 wt %-5 wt %.

By way of example, the mass percentage content of the positive electrode active material in the positive electrode active material layer may be, for example, 90 wt %, 91 wt %, 92 wt %, 93 wt %, 94 wt %, 95 wt %, 96 wt %, 97 wt %, 98 wt %, 99.4 wt % or any point value in a range consisting of two of the above point values.

By way of example, the mass percentage content of the conductive agent in the positive electrode active material layer may be, for example, 0.3 wt %, 0.6 wt %, 1 wt %, 2 wt %, 3 wt %, 4 wt %, 5 wt %, or any point value in a range consisting of two of the above point values.

By way of example, the mass percentage content of the adhesive in the positive electrode active material layer may be, for example, 0.3 wt %, 0.6 wt %, 1 wt %, 2 wt %, 3 wt %, 4 wt %, 5 wt %, or any point value in a range consisting of two of the above point values.

In some embodiments, the mass percentage content of each component in the negative electrode active material layer is as follow: a negative electrode active material: 90 wt %-99.4 wt %, a conductive agent: 0.2 wt %-5 wt %, and an adhesive: 0.4 wt %-5 wt %.

By way of example, the mass percentage content of the negative electrode active material in the negative electrode active material layer may be, for example, 90 wt %, 91 wt %, 92 wt %, 93 wt %, 94 wt %, 95 wt %, 96 wt %, 97 wt %, 98 wt %, 99.4% or any point value in a range consisting of two of the above point values.

By way of example, the mass percentage content of the conductive agent in the negative electrode active material layer may be, for example, 0.2 wt %, 0.4 wt %, 0.6 wt %, 0.8 wt %, 1 wt %, 2 wt %, 3 wt %, 4 wt %, 5 wt %, or any point value in a range consisting of two of the above point values.

By way of example, the mass percentage content of the adhesive in the negative electrode active material layer may be, for example, 0.4 wt %, 0.6 wt %, 0.8 wt %, 1 wt %, 2 wt %, 3 wt %, 4 wt %, 5 wt %, or any point value in a range consisting of two of the above point values.

In some embodiments, the conductive agent comprises, but not limited to, one or more of conductive carbon black, acetylene black, Ketjen black, conductive graphite, conductive carbon fiber, carbon nanotube, and metal powder.

In some embodiments, the adhesive comprises, but not limited to, one or more of a styrene-butadiene rubber emulsion, a polytetrafluoroethylene emulsion, sodium carboxymethyl cellulose, sodium alginate, polyvinyl alcohol, polyacrylic acid, lithium polyacrylate, sodium polyacrylate and carboxylated chitosan.

In some embodiments, the lithium ion electrolyte solution further includes a lithium salt, which can be selected from one or more of lithium hexafluorophosphate (LiPF₆), lithium difluorophosphate (LiPO₂F₂), lithium hexafluoroantimonate (LiSbF₆), lithium hexafluoroarsenate (LiAsF₆), lithium bis(fluorosulfonyl)imide (LiFSI), lithium bis(trifluoromethanesulfonyl)imide (LiTFSI), lithium trifluoromethanesulfonate, lithium bis(trifluoromethanesulfonyl)imide, lithium bis(pentafluoroethylsulfonyl)imide, lithium tris(trifluoromethanesulfonyl)methide or lithium bis(trifluoromethanesulfonyl)imide, lithium difluorooxalatoborate (LiDFOB), lithium difluorobis(oxalato)phosphate, lithium tetrafluoroborate (LiBF₄), lithium bis(difluorophosphoryloxy)difluoroborate, and lithium tetra(difluorophosphoryloxy)borate. Based on the total mass of the electrolyte solution, the mass percentage of the lithium salt is 12.5%-25%, and can be, for example, 12.5%, 15%, 18%, 20%, 22%, 24%, 25% or any point value in a range consisting of two of the above point values. The addition of lithium salts satisfying the above range to the electrolyte solution can improve the ionic conductivity of the electrolyte solution, improve the charge/discharge efficiency of the battery, and improve the fast charging performance of the battery.

In some embodiments, the lithium ion electrolyte solution further includes other additives which may be selected from one or more additives commonly used in the art to further improve the cycling performance or high and low temperature performance of the battery. By way of example, the additives include, but not limited to, one or more of vinylene carbonate (VC), fluoroethylene carbonate (FEC), succinonitrile (SN), adiponitrile (AND), glutaronitrile (GN), hexanetricarbonitrile (HTCN), ethylene glycol bis(propionitrile) ether (DENE), glycerol tricarbonitrile (TCP), tetravinylsilane (TVS), tris(trimethylsilyl)borate (TMSB), hexamethyldisilazane (HMDS), fluorobenzene (FB), triphenyl phosphite (TPPi), and pentafluoroethoxy cyclotriphosphazene (PFPN). Based on the total mass of the electrolyte solution, the mass percentage of the other additives is 8%-20%, and can be, for example, 8%, 10%, 12%, 14%, 16%, 18%, 20% or any point value in a range consisting of two of the above point values.

The technical solutions of the embodiments of the present disclosure will be clearly and completely described combined with the embodiments of the present disclosure as below, clearly, the embodiments described are merely a part of the embodiments of the present disclosure rather than all of the embodiments of the present disclosure. On the basis of the embodiments of the disclosure, all the other embodiments obtained by those of ordinary skill in the art without creative efforts fall within the scope of protection of the present disclosure.

The materials, reagents, etc. used in the following examples are all commercially available, unless otherwise specified.

The present disclosure will be described below in detail combined with specific examples, which are intended to understand but not to limit the present disclosure.

### Example 1-1

### (1) Preparation of Negative Electrode Plate:

A negative electrode active material (composed of 90 wt % artificial graphite+10 wt % of the silicon-carbon composite material), a styrene-butadiene rubber (SBR), lithium polyacrylate, conductive carbon black (SP) and carbon nanotubes (CNT) were mixed until uniform at a mass ratio of 96.5:1.5:0.5:1.0:0.5, then an appropriate amount of deionized water was added stepwise to obtain a negative electrode slurry under the action of a vacuum mixer. The sphericity Q of the silicon-carbon composite material used was 0.9, and the oil absorption value was 40 mL/100 g. The negative electrode active slurry was uniformly coated on both surfaces of a copper foil using a coating machine. The coated copper foil was air-dried at room temperature until surface is dry, and then transferred to an oven at 80° C. for drying for 10 h, followed by rolling, laser ablation, and slitting to obtain the negative electrode plate. the depth of the depression formed by the laser ablation of negative electrode was 20 μm and the groove distance between wires was 2 mm.

### (2) Preparation of Positive Electrode Plate:

A carbon coated lithium cobaltate (LiCoO₂@C) material, polyvinylidene fluoride (PVDF), conductive carbon black (SP) and carbon nanotubes (CNTs) were dry-blended at a mass ratio of 96:2.0:1.5:0.5. Then an appropriate amount of N-methylpyrrolidone (NMP) was added stepwise and mixed under the action of a vacuum mixer to form a homogeneous slurry. Subsequently, the positive electrode active slurry was uniformly coated on both surfaces of an aluminum foil using a coating machine. The coated aluminum foil was dried, followed by rolling and slitting to obtain the desired positive electrode plate.

### (3) Preparation of Separator:

A 2-μm-thick alumina layer (composed of 92 wt % alumina, 4 wt % methacrylic acid, and 4 wt % sodium polymethylcellulose) was coated on the first surface of a porous polypropylene substrate having a thickness of 5 μm, the alumina particles having an average particle size of 0.5 μm. Then, an adhesive layer with a thickness of 1 μm was coated on the second surface of the polypropylene substrate opposite to the first surface and the surface of the alumina layer, respectively, the material of the adhesive layer being PVDF.

### (4) Formulation of Electrolyte Solution:

In a glove box filled with argon (H₂O<0.1 ppm, and O₂<0.1 ppm), ethylene carbonate (EC), propylene carbonate (PC), ethyl butyrate (EB, a carboxylate ester solvent), and n-propyl acetate (PA, a carboxylate ester solvent) were mixed until uniform at an appropriate mass ratio. 12 wt % of LiPF₆ and 5 wt % of LiTFSI based on the total mass of the electrolyte solution were then rapidly added thereto, and after dissolution, 10 wt % of FEC, 1.0 wt % of 1,3,6-hexanetrinitrile (HTCN), 0.5 wt % of a sulfur-containing monoheterocyclic compound B of formula XVI and 1.5 wt % of a sulfur-containing polyheterocyclic compound A of formula I based on the total mass of the electrolyte solution were added. After stirring until uniform, the mixture passed the tests of moisture, free acid and chromaticity and was confirmed to meet specifications, then the desired electrolyte solution was obtained. In the electrolyte solution, the combined mass percentage of ethyl butyrate and n-propyl acetate was 45%, and the mass ratio of ethylene carbonate to propylene carbonate was 1:1 (the combined mass percentage of both varying depending on the mass percentage of the carboxylate ester solvent).

### (5) Preparation of Lithium-Ion Battery:

The negative electrode plate, the separator, the positive electrode plate were stacked in a certain manner, ensuring the separator completely isolating the positive and negative electrodes, while allowing the negative electrode paste to fully cover the positive electrode paste, and then the obtained material was winded into a core with a certain thickness and width. Then, the material was packaged using an aluminum plastic film and injected with the electrolyte solution prepared in the previous step, followed by the procedures of encapsulation under vacuum, ageing, formation, shaping, sorting, etc. to yield a soft-pack lithium-ion battery with certain specifications. The prepared lithium ion had a voltage testing window of 3.0 V-4.53 V.

### (6) Test Method for Performance Parameters:

(i) K value test method: The lithium-ion battery sorted out of stage was measured for the open circuit potential yielding V1, and left to stand for 24 h, the battery was measured for the open circuit potential again yielding V2, and the K-value of the battery was obtained by dividing the difference between V1 and V2 by the standing time.
(ii) Hot box passing test: First, the lithium-ion battery was fully charged at a constant current and constant voltage of 0.5 C, and the fully charged battery was placed in a thermostat at 20±5° C. Then, the temperature was raised to the target temperature at a rate of 5° C./min and held at the target temperature for 30 min. The battery passes the hot box test if no fire or explosion occurs within 30 min.
(iii) Cycling performance test: In a thermostat at 25° C., the battery was charged stepwise at an initial rate of 4 C to the upper limit voltage, followed by constant-voltage (CV) charging until the current dropped to 0.05 C, which was a charging process, and after charging was completed, the battery was left to stand for 10 min, and then discharged at rate of 0.7 C to 3.0 V. A charge-discharge process was a cycle. The cycling life of the battery was characterized by reducing the capacity of the battery to 80% of the initial capacity thereof.
(iv) Separator-negative electrode plate adhesion test method

The batteries obtained from the above examples and comparative examples were placed in an environment of (25±2°) C, and left to stand for 2-3 h, and the batteries were charged at a constant current of 0.7 C, with a cut-off current being 0.05 C. When the battery terminal voltage reached the charging limit voltage, the charging was switched to constant voltage charging until the charging current≤cutoff current, the charging was stopped, and the batteries were left to stand for 5 min. The fully charged batteries were dissected, and the adhesion between the separator and positive or negative electrode plate was measured according to the Chinese National Standard GB/T 2790-1995 (equivalent to the 180° peel test standard), the separator and negative electrode plate were cut into 15 mm×54.2 mm strips, and then the adhesion between the separator and the negative electrode plate was measured according to the 1800 peel test standard.
(v) Test method for particle size of silicon-carbon composite material: The particle size Dv10, Dv50, and Dv90 can be measured by means of a laser particle size test method. For example, a Malvern Mastersizer was used for measuring the particle size by means of the following measuring steps: dispersing a composite material in deionized water containing a dispersant (e.g., nonylphenol polyoxyethylene ether, with a content of 0.02-0.03 wt %) to form a mixture, subjecting same to an ultrasonic treatment for 2 min, and then placing same into the Malvern Mastersizer for measurement.
(vi) Storage test at 60° C. for lithium-ion battery:

The lithium-ion battery was fully charged and placed in a thermostat at 60° C. and the thickness of the battery was measured every 3 days until the thickness of the battery expanded more than 10% of the initial thickness. The days recorded (D) were the storage life of the lithium-ion battery at 60° C.

Example groups 1-3, and Comparative Example 1-Comparative Example 4 followed example 1-1, with the main differences shown in Table 1. The mass percentage of the carboxylate ester solvent in the electrolyte solution was varied in example group 1. The mass percentage of the sulfur-containing heterocyclic compound in the electrolyte solution was varied in example group 2. In Example group 3, the sphericity of the silicon-carbon material was varied. In Comparative Example 1, the mass percentage of the carboxylate ester solvent in the electrolyte solution was too small. In Comparative Example 2, the mass percentage of the sulfur-containing heterocyclic compound was too small. In Comparative Example 3, the mass percentage of the sulfur-containing heterocyclic compound was excessively high. In Comparative Example 4, no sulfur-containing heterocyclic compound was added.

TABLE 1

| | Percentage | Percentage | | | | | | |
|---|---|---|---|---|---|---|---|---|
| | of | of sulfur- | Sphericity | | | | | Number |
| | carboxylate | containing | Q of | | | | | of cycles |
| | ester | heterocyclic | silicon- | | | | Storage | to 80% of |
| | solvent | compound | carbon | | K | Hot box | test at | initial |
| | E % | S % | material | E/S | value | test | 60° C. | capacity |
| Example 1-1 | 45 | 2 | 0.9 | 22.5 | 0.045 | passed at | 36 D | 1152 |
| | | | | | | 132° C. | | |
| Example 1-2 | 30 | 2 | 0.9 | 15 | 0.043 | passed at | 36 D | 1044 |
| | | | | | | 132° C. | | |
| Example 1-3 | 60 | 2 | 0.9 | 30 | 0.046 | passed at | 33 D | 1091 |
| | | | | | | 132° C. | | |
| Example 1-4 | 70 | 2 | 0.9 | 35 | 0.047 | passed at | 30 D | 777 |
| | | | | | | 130° C. | | |
| Example 2-1 | 45 | 0.5 | 0.9 | 90 | 0.091 | passed at | 27 D | 855 |
| | | | | | | 130° C. | | |
| Example 2-2 | 45 | 5 | 0.9 | 9 | 0.022 | passed at | 60 D | 798 |
| | | | | | | 134° C. | | |
| Example 2-3 | 30 | 0.3 | 0.9 | 100 | 0.330 | passed at | 15 D | 713 |
| | | | | | | 126° C. | | |
| Example 3-1 | 45 | 2 | 0.7 | 22.5 | 0.051 | passed at | 36 D | 1105 |
| | | | | | | 132° C. | | |
| Example 3-2 | 45 | 2 | 0.5 | 22.5 | 0.057 | passed at | 33 D | 1063 |
| | | | | | | 131° C. | | |
| Example 3-3 | 45 | 2 | 0.3 | 22.5 | 0.064 | passed at | 30 D | 728 |
| | | | | | | 128° C. | | |
| Comparative | 20 | 2.5 | 0.9 | 8 | 0.042 | passed at | 45 D | 518 |
| example 1 | | | | | | 132° C. | | |
| Comparative | 45 | 0.2 | 0.9 | 225 | 0.610 | passed at | 12 D | 542 |
| example 2 | | | | | | 125° C. | | |
| Comparative | 45 | 6 | 0.9 | 7.5 | 0.021 | passed at | 66 D | 492 |
| example 3 | | | | | | 135° C. | | |
| Comparative | 45 | / | 0.9 | / | 0.76 | passed at | 12 D | 455 |
| example 4 | | | | | | 124° C. | | |

Note: “/” indicates that the corresponding parameter was not tested.

As can be seen from Table 1, in the present disclosure, by adjusting the sphericity Q of the silicon-carbon material in the range of 0.5 to 1, while adjusting the mass percentage E of the carboxylate ester solvent and the mass percentage S of the sulfur-containing heterocyclic compound in the electrolyte solution to satisfy 10≤E/S≤100, the lithium-ion battery can have a good kinetic performance, and a higher energy density, a better cycling stability and a better thermal safety performance.

Example group 4 followed example 1-1, with the main differences shown in Table 2. the mass percentage of the sulfur-containing heterocyclic compound in the electrolyte solution in Example group 4 was kept constant, and the type of the sulfur-containing heterocyclic compounds or the proportional relationship between the sulfur-containing polyheterocyclic compound A and the sulfur-containing monoheterocyclic compound B was varied.

TABLE 2

| | Type of sulfur- | | | | |
|---|---|---|---|---|---|
| | containing | | | storage | Number of |
| | heterocyclic | K | Hot box | test at | cycles to 80% of |
| | compound | value | test | 60° C. | initial capacity |
| Example 1-1 | Formula I and | 0.045 | passed at | 36D | 1152 |
| | Formula XVI, | | 132° C. | | |
| | with a mass ratio | | | | |
| | of 3:1 | | | | |
| Example 4-1 | Formula I and | 0.047 | passed at | 39D | 1021 |
| | Formula XVI, | | 131° C. | | |
| | with a mass ratio | | | | |
| | of 1:1 | | | | |
| Example 4-2 | Formula I and | 0.041 | passed at | 27D | 1116 |
| | Formula XVI, | | 133° C. | | |
| | with a mass ratio | | | | |
| | of 6:1 | | | | |
| Example 4-3 | formula I | 0.045 | passed at | 21D | 1005 |
| | | | 130° C. | | |
| Example 4-4 | Formula XVI | 0.049 | passed at | 42D | 894 |
| | | | 128° C. | | |
| Example 4-6 | formula II and | 0.046 | passed at | 36D | 1107 |
| | formula XIV, | | 132° C. | | |
| | with a mass ratio | | | | |
| | of 3:1 | | | | |
| Example 4-7 | formula XI and | 0.047 | passed at | 36D | 1098 |
| | formula XIX, | | 132° C. | | |
| | with a mass ratio | | | | |
| | of 3:1 | | | | |

As can be seen from Table 2, in the present disclosure, the cycling life and thermal safety performance of lithium-ion batteries can be further improved by adjusting the type and proportion of sulfur-containing heterocyclic compounds added to the electrolyte solution.

Example groups 5-6 followed example 1-1, with the main differences shown in Table 3. The mass content of silicon element in the silicon-carbon material was varied in Example group 5. The thickness of the carbon coating layer was varied in example group 6.

TABLE 3

| | Mass content | | | | | |
|---|---|---|---|---|---|---|
| | of silicon | | | | | |
| | element in | Thickness | | | | Number of |
| | silicon- | of carbon | | | storage | cycles to 80% |
| | carbon | coating | K | Hot box | test at | of initial |
| | material % | layer/nm | value | test | 60° C. | capacity |
| Example | 50 | 100 | 0.045 | passed at | 36 D | 1124 |
| 1-1 | | | | 132° C. | | |
| Example | 35 | 100 | 0.044 | passed at | 33 D | 1106 |
| 5-1 | | | | 131° C. | | |
| Example | 70 | 100 | 0.048 | passed at | 30 D | 1043 |
| 5-2 | | | | 130° C. | | |
| Example | 50 | 10 | 0.047 | passed at | 33 D | 925 |
| 6-1 | | | | 132° C. | | |
| Example | 50 | 500 | 0.041 | passed at | 39 D | 904 |
| 6-2 | | | | 132° C. | | |

As can be seen from Table 3, in the present disclosure, by adjusting the mass content of silicon element in the silicon-carbon material, it is possible to ensure that the lithium-ion battery has a good thermal safety performance, cycling life, and fast charging performance, while the negative electrode material has a higher lithium storage capacity per gram, which further increases the energy density of the lithium-ion battery; by adjusting the thickness of the carbon coating layer, the silicon-carbon composite material can have better kinetics and cycling stability.

Example groups 7-8 followed Example 1-1, with the main differences shown in Table 4. The depth of the depression and/or the oil absorption value of the silicon-carbon material were varied in example group 7. In example group 8, the distance between the adjacent linear grooves was varied.

TABLE 4

| | | Oil | | | | | | |
|---|---|---|---|---|---|---|---|---|
| | | absorption | | | | | | Separator- |
| | | value of | Distance | | | | Number of | negative |
| | | silicon- | between | | | | cycles to | electrode |
| | Depth of | carbon | adjacent | | | storage | 80% of | plate |
| | depression | material | linear | K | Hot box | test at | initial | adhesion |
| | X/μm | Y mL/100 g | grooves/mm | value | test | 60° C. | capacity | N/m |
| Example | 20 | 40 | 2 | 0.045 | passed at | 36 D | 1152 | 12.5 |
| 1-1 | | | | | 132° C. | | | |
| Example | 15 | 40 | 2 | 0.042 | passed at | 36 D | 1003 | 13.1 |
| 7-1 | | | | | 132° C. | | | |
| Example | 5 | 40 | 2 | 0.043 | passed at | 39 D | 916 | 13.8 |
| 7-2 | | | | | 133° C. | | | |
| Example | 25 | 40 | 2 | 0.051 | passed at | 33 D | 878 | 11.6 |
| 7-3 | | | | | 130° C. | | | |
| Example | 45 | 60 | 2 | 0.066 | passed at | 27 D | 731 | 8.4 |
| 7-4 | | | | | 128° C. | | | |
| Example | 5 | 10 | 2 | 0.041 | passed at | 45 D | 643 | 14.4 |
| 7-5 | | | | | 134° C. | | | |
| Example | 20 | 40 | 0.5 | 1.520 | passed at | 21 D | 510 | 4.6 |
| 8-1 | | | | | 124° C. | | | |
| Example | 20 | 40 | 3.5 | 0.028 | passed at | 45 D | 623 | 14.8 |
| 8-2 | | | | | 134° C. | | | |

As can be seen from Table 4, the present disclosure can improve the infiltration of the electrolyte solution, improve the electrolyte retention capacity of the battery, mitigate the problem of lithium precipitation and improve the fast charging performance of lithium-ion battery by adjusting the depth X of the depression and the oil absorption value Y of the silicon-carbon material. By adjusting the distance between adjacent linear grooves, the negative electrode plate can have better adhesion to the separator, the lithium-ion battery is less prone to deformation, the infiltration of the electrolyte solution is further improved, and the electrolyte retention capacity of the battery is improved, and the problem of lithium precipitation at interfaces in lithium-ion batteries is mitigated, the fast charging performance of the lithium-ion battery is improved, and the cycling life is prolonged.

Example groups 9-10 followed example 1-1, with the main differences shown in Table 5. The Dv50 of the inorganic particles in the heat-resistant coating was varied in Example group 9. The mass percentage of sulfur-containing heterocyclic compounds in the electrolyte solution was varied in example group 10.

TABLE 5

| | Dv50 of | Mass | | | | | |
|---|---|---|---|---|---|---|---|
| | inorganic | percentage | | | | | |
| | particles | of sulfur- | | | | | Number |
| | in heat- | containing | | | | | of cycles |
| | resistant | heterocyclic | | | | storage | to 80% |
| | coating | compound | | K | Hot box | test at | of initial |
| | (W) | S % | S/W | value | test | 60° C. | capacity |
| Example | 0.5 | 2 | 4 | 0.045 | passed at | 36 D | 1152 |
| 1-1 | | | | | 132° C. | | |
| Example | 0.2 | 2 | 10 | 0.024 | passed at | 36 D | 1102 |
| 9-1 | | | | | 134° C. | | |
| Example | 1 | 2 | 2 | 0.058 | passed at | 36 D | 1126 |
| 9-2 | | | | | 130° C. | | |
| Example | 2 | 2 | 1 | 0.131 | passed at | 36 D | 1112 |
| 9-3 | | | | | 128° C. | | |
| Example | 4 | 1 | 0.3 | 1.251 | passed at | 21 D | 902 |
| 9-4 | | | | | 122° C. | | |
| Example | 0.2 | 0.5 | 2.5 | 0.049 | passed at | 30 D | 855 |
| 10-1 | | | | | 130° C. | | |
| Example | 0.2 | 4 | 20 | 0.021 | passed at | 51 D | 826 |
| 10-2 | | | | | 134° C. | | |

As can be seen from Table 5, according to the present disclosure, by adjusting the Dv50 (W) of inorganic particles in the heat-resistant coating and the mass percentage (S) of the sulfur-containing heterocyclic compound in the electrolyte solution, and when S and W satisfy 0.5≤S/W≤20, the synergistic effect between the inorganic heat-resistant coating and the sulfur-containing heterocyclic compound can make the prepared lithium-ion battery have a better ability to suppress self-discharge and a better thermal safety performance.

It should be noted that, as used herein, terms “comprise”, “include”, or any other variants thereof are intended to encompass a non-exclusive inclusion such that a process, method, article, or device which includes a series of elements not only includes these very elements, but may also include other elements not expressly listed, or also include elements inherent to this process, method, article, or device. Without being subject to further limitations, an element defined by a phrase “including . . . ” does not exclude presence of other identical elements in the process, method, article, or device which includes the element. Furthermore, it should be noted that the scopes of the methods and devices in the embodiments of the present application are not limited to performing functions in the order shown or discussed, but may also include performing functions in a substantially simultaneous manner or in a reverse order depending on the functions involved. For example, the described method may be performed in an order different from that described, and various steps may be added, omitted, or combined. Additionally, features described with reference to some examples may be combined in other examples.

The above descriptions are merely preferred embodiments of the present disclosure but not intended to limit the present disclosure, and any modifications, equivalent replacements, etc. made within the spirit and principle of the present disclosure should be included within the scope of protection of the present disclosure.

1. A lithium-ion secondary battery, comprising:
a positive electrode plate;
a negative electrode plate; and
an electrolyte solution, wherein
the negative electrode plate comprises a negative electrode active material, wherein the negative electrode active material comprises a carbon-based material and a silicon-based material, the silicon-based material comprises a silicon-carbon material, the silicon-carbon material comprises a porous carbon substrate and a silicon material distributed within pores of the porous carbon substrate, and a sphericity of the silicon-carbon material is denoted as Q, with the sphericity Q being 0.5-1;
the electrolyte solution comprises a carboxylate ester solvent, based on a total mass of the electrolyte solution, a mass percentage of the carboxylate ester solvent is denoted as E %; and
the electrolyte solution comprises a sulfur-containing heterocyclic compound, based on the total mass of the electrolyte solution, a mass percentage of the sulfur-containing heterocyclic compound is denoted as S %; and
E and S satisfy: 10≤E/S≤100.

2. The lithium-ion secondary battery according to claim 1, wherein E and S satisfy: 15≤E/S≤80;
and/or, a mass percentage E of the carboxylate ester solvent is 30% to 60%;
and/or, a mass percentage S of the sulfur-containing heterocyclic compound is 0.5% to 5%.

3. The lithium-ion secondary battery according to claim 1, wherein the sulfur-containing heterocyclic compound comprises a sulfur-containing polyheterocyclic compound A, and/or a sulfur-containing monoheterocyclic compound B;
preferably, the sulfur-containing heterocyclic compound comprises: a sulfur-containing polyheterocyclic compound A and a sulfur-containing monoheterocyclic compound B;
preferably, a mass ratio of the sulfur-containing polyheterocyclic compound A to the sulfur-containing monoheterocyclic compound B is (2-6):1.

4. The lithium-ion secondary battery according to claim 3, wherein the sulfur-containing polyheterocyclic compound A comprises at least one of the following compounds: 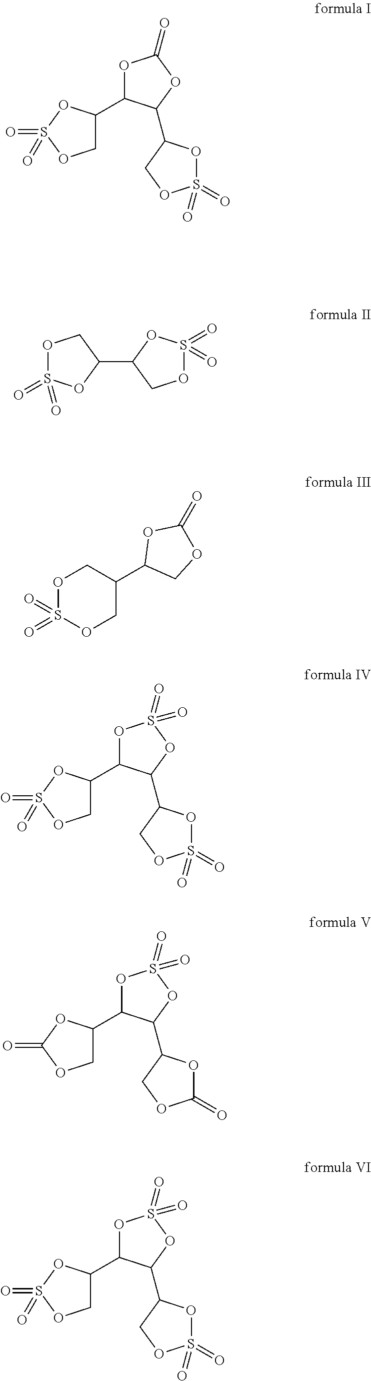 [SMILES: O=C1OC(C2COS(=O)(=O)O2)C(C2COS(=O)(=O)O2)O1 ; O=S1(=O)OCC(C2COS(=O)(=O)O2)O1 ; O=C1OCC(C2COS(=O)(=O)OC2)O1 ; O=S1(=O)OCC(C2OS(=O)(=O)OC2C2COS(=O)(=O)O2)O1 ; O=C1OCC(C2OS(=O)(=O)OC2C2COC(=O)O2)O1 ; O=S1(=O)OCC(C2OS(=O)(=O)OC2C2COS(=O)(=O)O2)O1] 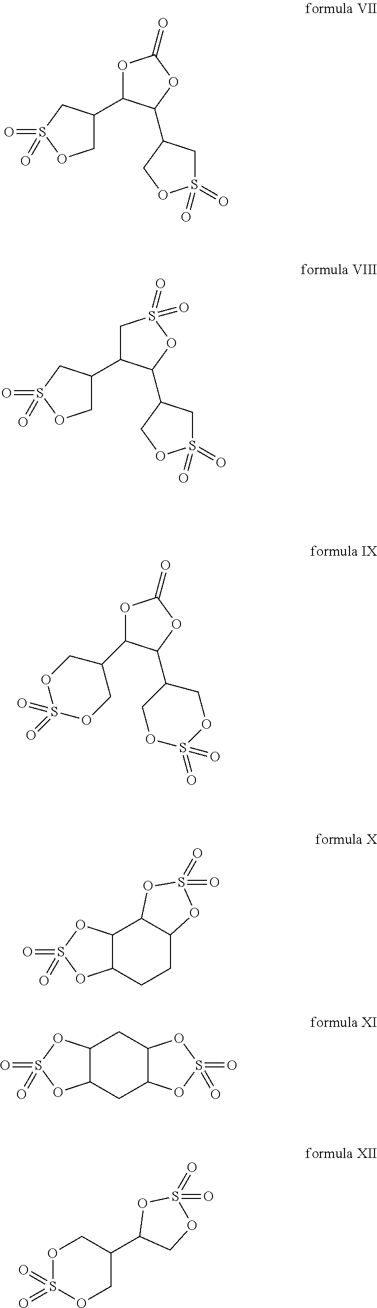 [SMILES: O=C1OC(C2COS(=O)(=O)C2)C(C2COS(=O)(=O)C2)O1 ; O=S1(=O)CC(C2CS(=O)(=O)OC2C2COS(=O)(=O)C2)CO1 ; O=C1OC(C2COS(=O)(=O)OC2)C(C2COS(=O)(=O)OC2)O1 ; O=S1(=O)OC2CCC3OS(=O)(=O)OC3C2O1 ; O=S1(=O)OC2CC3OS(=O)(=O)OC3CC2O1 ; O=S1(=O)OCC(C2COS(=O)(=O)O2)CO1] 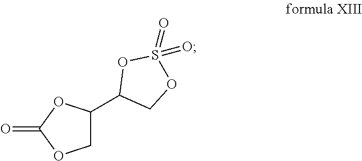 [SMILES: O=C1OCC(C2COS(=O)(=O)O2)O1]
and/or, the sulfur-containing monoheterocyclic compound B comprises at least one of the following compounds.

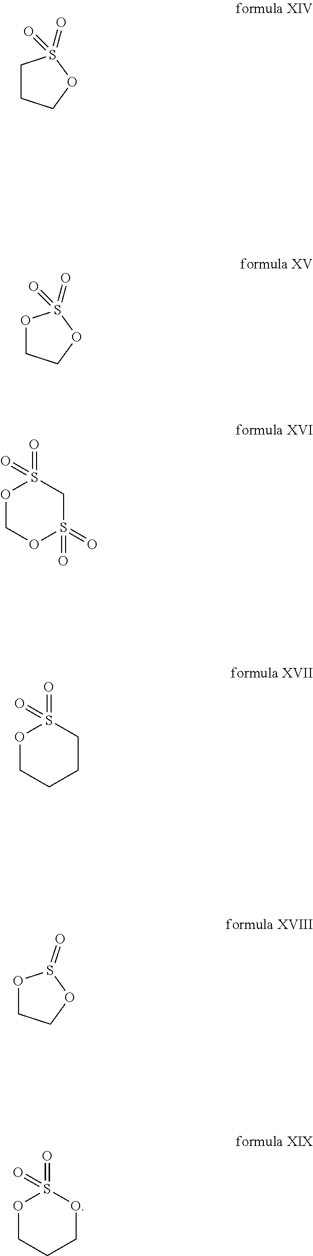 [SMILES: O=S1(=O)CCCO1 ; O=S1(=O)OCCO1 ; O=S1(=O)CS(=O)(=O)OCO1 ; O=S1(=O)CCCCO1 ; O=S1OCCO1 ; O=S1(=O)OCCCO1]

5. The lithium-ion secondary battery according to claim 1, wherein a mass content of silicon in the silicon-carbon material is 35%-70%;
preferably, the silicon-carbon material has the following volume distributions: Dv10 of 3 μm-6 μm, Dv50 of 6 μm-12 μm, and Dv90 of 12 μm-25 μm;
preferably, the silicon-carbon material comprises a carbon coating layer, which has a thickness of 10 nm-500 nm.

6. The lithium-ion secondary battery according to claim 1, wherein the negative electrode plate comprises a negative electrode current collector and a negative electrode active material layer disposed on at least one surface of the negative electrode current collector; the negative electrode active material layer is provided with a recessed region which comprises at least one depression;
the negative electrode active material layer comprises the negative electrode active material;
a depth of the depression is denoted as X μm, X satisfying: 5≤X≤45, preferably 5≤X≤30; and/or
the silicon-carbon material has an oil absorption value which is denoted as Y mL/100 g, Y satisfying: 10≤Y≤100, preferably 20≤Y≤50.

7. The lithium-ion secondary battery according to claim 6, wherein a contour of the depression is a linear groove, a regular hole shape or an irregular hole shape;
preferably, when the contour of the depression is a linear groove, a distance between adjacent two linear grooves is 1 mm-3 mm;
preferably, when the contour of the depression is a regular hole shape or an irregular hole shape, the distance between adjacent two holes is 100 μm-300 μm.

8. The lithium-ion secondary battery according to claim 6, further comprising a separator, wherein
the separator comprises a porous substrate, a heat-resistant coating, and a porous adhesive layer, which are sequentially stacked, wherein
the heat-resistant coating comprises inorganic particles which have a Dv50 denoted as W m;
S and W satisfy: 0.5≤S/W≤20, preferably 1≤S/W≤15;
preferably, the Dv50 of the inorganic particles is 0.2 μm-2 μm.

9. The lithium-ion secondary battery according to claim 8, wherein the adhesion between the separator and the negative electrode plate is >5 N/m;
preferably, the porous substrate of the separator has a thickness of 3 μm-8 μm; and/or, the heat-resistant coating has a thickness of 0.5 μm-3 μm; and/or, the porous adhesive layer has a thickness of 0.5 μm-3 μm.

10. The lithium-ion secondary battery according to claim 1, wherein the carboxylate ester solvent comprises a C1-C10 carboxylate ester solvent; preferably, the C1-C10 carboxylate ester solvent comprises one or more of n-propyl propionate, ethyl propionate, methyl propionate, n-butyl propionate, methyl acetate, ethyl acetate, n-propyl acetate, n-butyl acetate, methyl butyrate, ethyl butyrate, and propyl butyrate; and
the positive electrode plate comprises a positive electrode active material which comprises a lithium cobaltate-based layered oxide material.
